(19) United States
(12) Patent Application Publication
(10) Pub. No.: US 2013/0006626 A1
(43) Pub. Date: Jan. 3, 2013

(54) VOICE-BASED TELECOMMUNICATION LOGIN

(75) Inventors: Chandrasekara Aiyer, Homebush Bay (AU); Brent W. Bennet, Croydon Hills (AU); Elizabeth J. Carey, Duffys Forest (AU); Chuanfeng Li, Marsfield (AU); Faisal Mansoor, Casula (AU); Duncan E. Russell, Berowra (AU); Aditi Sharma, West Pennant Hills (AU)

(73) Assignee: International Business Machines Corporation, Armonk, NY (US)

(21) Appl. No.: 13/171,765

(22) Filed: Jun. 29, 2011

(51) Int. Cl. G10L 15/26

(52) U.S. Cl. 704/235; 704/E15.043

(57) ABSTRACT

A voice-based telecommunications login system which includes a login process controller; a speech recognition module; a speaker verification module; a speech synthesis module; and a user database. Responsive to a user-provided first verbal answer to a first verbal question, the first verbal answer is converted to text and compared with data previously stored in the user database. The speech synthesis module provides a second question to the user, and responsive to a user-provided second verbal answer to the second question, the speaker verification module compares the second verbal answer with a voice print of the user previously stored in the user database and validates that the second verbal answer matches a voice print of the user previously stored in the user database. Also disclosed is a method of logging in to the telecommunications system and a computer program product for logging in to the telecommunications system.

### BACKGROUND

The exemplary embodiments relate generally to voice recognition, and more particularly, relate to a voice only log-in method for granting a person access to a telecommunication system, without keying in any additional codes or passwords.

It is useful for staff who regularly work in different locations, or for staff who are moving around in their place of work, to be able to use any phone as if it were their own phone. The Extension Mobility feature of telecommunication systems allows you to temporarily configure a phone as your own phone by logging in to the telecommunications system to which the phone is connected. Once the person has logged in to the telecommunications system, the phone may adopt the profile information of the person, including telephone number, call forwards etc.

The person may login using verbal interaction which requires that the telecommunication system have speaker recognition capability.

Speaker recognition generally includes the two application areas of speaker identification and speaker verification: speaker identification involves labeling an unknown voice as one from a set of known voices, while speaker verification involves determining whether an unknown voice matches the known voice of a speaker whose identity is being claimed. In particular, speaker identity verification based on a person's voice is of considerable interest for providing telephone access to such services as banking transactions, credit card verification, remote access to dial-up computer databases.

### BRIEF SUMMARY

The various advantages and purposes of the exemplary embodiments as described above and hereafter are achieved by providing, according to a first aspect of the exemplary embodiments, a voice-based telecommunications login system which includes a login process controller to run login process instances and other modules of the login system; a speech recognition module to receive, recognize and transform a user's voice to text; a speaker verification module to verify the user's identity based on verbal dialogue from the user; a speech synthesis module to synthesize a voice to provide verbal dialogue to the user; and a user database to store voice prints of the user. In operation, responsive to a user-provided first verbal answer to a first verbal question generated by the login system, the first verbal answer is converted by the speech recognition module to text and compared with data previously stored in the user database, the speech synthesis module providing at least one second question to the user, and responsive to a user-provided second verbal answer to the at least one second question, the speaker verification module comparing the second verbal answer with a voice print of the user previously stored in the user database and validating that the second verbal answer matches the voice print of the user previously stored in the user database. The login system is implemented in one or more computing devices.

According to a second aspect of the exemplary embodiments, there is provided a method of logging in to a telecommunications system using a login system. The method includes providing a first verbal question to a user; responsive to a user-provided first verbal answer to the first verbal question, comparing the first verbal answer with data previously stored by the login system; generating at least one second verbal question after confirming a match between the first verbal answer and the data previously stored by the login system; responsive to a user-provided second verbal answer to the at least one second verbal question, comparing the second verbal answer with a voice print of the user previously stored by the login system; and providing access to the telecommunications system if the second verbal answer matches the voice print of the user previously stored by the login system. The method is performed by one or more computing devices.

According to a third aspect of the exemplary embodiments, there is provided a computer program product for logging in to a telecommunications system using a login system. The computer program product includes a computer readable non-transitory storage medium having computer readable program code embodied therewith. The computer readable program code includes computer readable program code configured to provide a first verbal question to a user; responsive to a user-provided first verbal answer to the first verbal question, computer readable program code configured to compare the first verbal answer with data previously stored by the login system; computer readable program code configured to generate at least one second verbal question after confirming a match between the first verbal answer and the voice print; responsive to a user-provided second verbal answer to the at least one second verbal question, computer readable program code configured to compare the second verbal answer with a voice print of the user previously stored by the login system; and computer readable program code configured to provide access to the telecommunications system if the second verbal answer matches the voice print of the user previously stored by the login system.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a computing environment of the exemplary embodiments.

FIG. 2 illustrates a computer that may be used in the computing environment of FIG. 1.

FIG. 3 is a schematic illustration of the various components of the exemplary embodiments.

FIG. 4 is a flow chart illustrating the various processes involved in the exemplary embodiments.

### DETAILED DESCRIPTION

The exemplary embodiments leverage speech processing technologies to implement a pure voice-based telecommunication login system. In the system, a user's identity may be authenticated by a fixed personal voice phrase(s) and a random voice answer(s). The voice-based login system doesn't depend on sights or even motions of users and may be used by visually impaired and other disabled people.

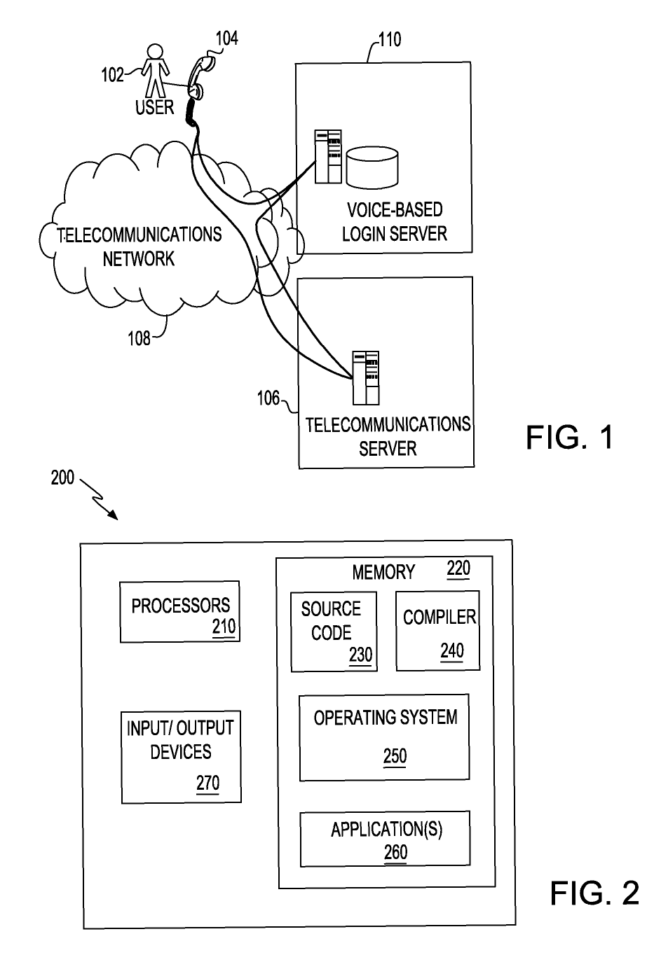

Referring to the Figures in more detail, and particularly referring to FIG. 1, an implementation of the exemplary embodiments is illustrated. A user 102 desires to temporarily use telephone 104 as his work telephone. Telephone 104 is not normally assigned to user 102. Telephone 104 is connected to telecommunications server 106 through telecommunications network 108. Telecommunications server 106 controls the functions of telephone 104 including functions such as extension number, call forwarding, and other well-known telephone functions.

Connected to telephone 104, telecommunications network 108 and telecommunications server 106 is voice-based login server 110. It should be understood that voice-based login server 110 may be a standalone server or be integrated with telecommunications server 106.

If the user 102 desires to configure telephone 104 for his/her use, user 102 may login to voice-based login server 110 which controls the user's access to telecommunications server 106. That is, voice-based login server 110 must authenticate the user 102 before the user 102 may access the telecommunications server 106 to configure telephone 110.

The voice-based login server 110 and the telecommunications server 110 may be functionally combined to form a call service center. The call service center may have an interface to interact with the user when the user wants to interact with the voice-based login server 110.

FIG. 2 illustrates an example of a computer 200 having capabilities to function as voice-based login server 110 and/or telecommunications server 106.

Generally, in terms of hardware architecture, the computer 200 may include one or more processors 210, computer readable memory 220, and one or more input and/or output (I/O) devices 270 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 210 is a hardware device for executing software that may be stored in the memory 220. The processor 210 can be virtually any custom made or commercially available processor, a central processing unit (CPU), a data signal processor (DSP), or an auxiliary processor among several processors associated with the computer 200, and the processor 210 may be a semiconductor based microprocessor in the form of a microchip or a macroprocessor.

The computer readable memory 220 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 220 may incorporate electronic, magnetic, optical, and/or other types of storage media. Note that the memory 220 may have a distributed architecture, where various components are situated remote from one another, but can be accessed by the processor 210.

The software in the memory 220 may include one or more separate programs, each of which comprises an ordered listing of executable instructions for implementing logical functions. The software in the memory 220 includes a suitable operating system (O/S) 250, compiler 240, source code 230, and one or more applications 260 of the exemplary embodiments. As illustrated, the application 260 comprises numerous functional components for implementing the features, processes, methods, functions, and operations of the exemplary embodiments. The application 260 of the computer 200 may represent numerous applications, agents, software components, modules, interfaces, etc., as discussed herein but the application 260 is not meant to be a limitation.

When the computer 200 is in operation, the processor 210 is configured to execute software stored within the memory 220, to communicate data to and from the memory 220, and to generally control operations of the computer 200 pursuant to the software. The application 260 and the O/S 250 are read, in whole or in part, by the processor 210, perhaps buffered within the processor 210, and then executed.

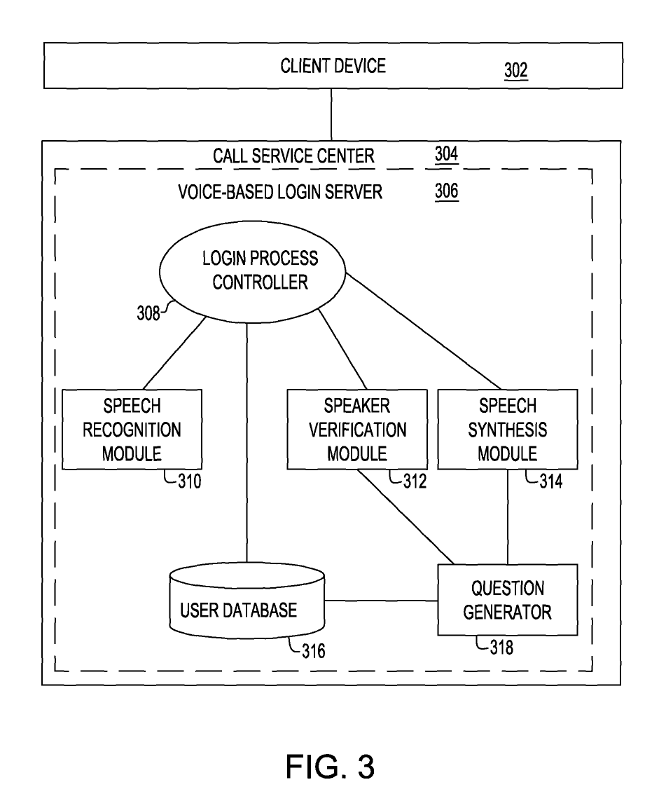

Referring now to FIG. 3, there is schematically illustrated the various components of the exemplary embodiments. Client device 302 may be the telephone that the user would like to configure. The client device 302 interacts with call service center 304 and voice-based login server 306. The call service center 304 schematically illustrates the telecommunications server 106 in FIG. 1 while voice-based login server 306 schematically illustrates the voice-based login server 110 in FIG. 1.

The voice-based login server 306 may include various components including, but not limited to, a login process controller 308, speech recognition module 310, speaker verification module 312, speech synthesis module 314, user database 316 and question generator 318.

The speaker recognition system of the exemplary embodiments has two phases: Enrollment and verification. During enrollment, the speaker's voice is recorded and typically a number of features are extracted to form a voice print, template, or model. In the verification phase, a speech sample or “utterance” is compared against a previously created voice print. For identification systems, the utterance is compared against multiple voice prints in order to determine the best match(es) while verification systems compare an utterance against a single voice print. Because of the process involved, verification is faster than identification.

Speaker recognition systems fall into two categories: text-dependent and text-independent.

If the text must be the same for enrollment and verification, this is called text-dependent recognition. In a text-dependent system, prompts can either be common across all speakers (e.g.: a common pass phrase) or unique. In addition, the use of shared-secrets (e.g.: passwords and PINs) or knowledge-based information can be employed in order to create a multi-factor authentication scenario.

Text-independent systems are most often used for speaker identification as they require very little if any cooperation by the speaker. In this case the text during enrollment and verification is different. In fact, the enrollment may happen without the user's knowledge, as in the case for many forensic applications. As text-independent technologies do not compare what was said at enrollment and verification, verification applications tend to also employ speech recognition to determine what the user is saying at the point of authentication.

The exemplary embodiments preferably may utilize a speaker recognition system which is text-dependent.

Each of the foregoing components now will be described in detail.

### Client Device 302:

A client device may be a simple telephone. A base unit with a handset or a headset, including an earphone and a microphone, may be enough for the client device, even if the client device does not include a keypad.

There are at least three methods for the client device to contact the call service center 304. In one method, the user pushes a special button on the client device to dial in a pre-configured number of the call service center 304. In a second method, if there is no keypad or button on the telephone, when the user picks up the handset or headset, the telephone automatically dials in the call service center 304. In the third method, if there is a voice dial helper, it may recognize the access number from the user's voice and dial in the call service center 304.

### Call Service Center 304:

The call service center 304 is used to control the entire phone network, including user login and logout, number resolution, call transfer, etc. The voice-based login server 306 may be one of the components of the call service center 304. The voice-based login server 306 may be totally integrated in the call service center 304 or may be a standalone server but functionally connected to the call service center 304.

The call service center has an access number to supply services to end users via telephones.

### Voice-Based Login Server 306:

The voice-based login server 306 is the key component that controls user login and may include various components including, but not limited to, a login process controller 308, speech recognition module 310, speaker verification module 312, speech synthesis module 314, user database 316 and question generator 318.

### Login Process Controller 308:

The login process controller 308 runs login process instances, such as maintaining the user's context and state, scheduling the other modules, etc.

### Speech Recognition Module 310:

This module receives, recognizes and transforms the user's voice to text. It's a mature technology to recognize only the 10 digits (0 to 9) in mainstream languages, such as English, Chinese, etc.

### Speech Synthesis Module 314:

This module synthesizes the voice used for the fixed and random questions that will be asked of the user.

If the speech synthesis module 314 is powerful, it may retrieve text fixed questions from the user database 316, text random questions from the question generator 318 and transform the text fixed and random questions to voice.

If the speech synthesis module 314 is not powerful enough, it may only retrieve the recorded fixed questions from the user database 316 and replay them to the user along with other voice prompts. For the random questions, it may retrieve the recorded snippets of the 10 digits and other prompt phrases from the user database 316 and assemble them according to the questions generated from the question generator 318.

### Speaker Verification Module 312:

Based on the received voice answer, the expected answer and the user's stored voice models, this module computes and compares to verify the user's identity.

Voices of answers for the fixed questions and the 10 digits for the random questions have been recorded in enrollment, and their voice models are created for later verification. The text is the same for enrollment and verification, as a text dependent recognition is more accurate than the text independent recognition.

### User Database 316:

The user database 316 stores the user's extension number, name, voice models, fixed questions, alternative languages and other preferences. If required, it may also store voice snippets for the 10 digits and other prompt phrases.

In a less confidential environment, the fixed questions may be the same for all users, such as prompting a user to speak the user name.

In a more confidential environment, the fixed questions may be different for each user. The fixed questions may be any phrases, such as his or her friend's names, birthdays or private lucky numbers. A phrase is like a password, so it's better if the phrase is unknown to others, but familiar to the user.

If the speech synthesis module 314 is powerful and can transform text to voice, the fixed questions may be stored as text in the user database 316.

If the speech synthesis module 314 is not powerful enough, especially for non-mainstream languages, the fixed questions may be simply recorded and stored in the user database 316. Similarly, the 10 digits and other prompt phrases for the random arithmetic questions may also be recorded and stored in the user database 316, no matter which language they are spoken in.

### Question Generator 318:

This module generates the random questions. Random questions are such that they must be analyzed by the user to give a correct answer. To ensure the quality of speech synthesis and improve the accuracy rate of speaker verification, it is preferred that only arithmetic questions are generated. For example:

Please repeat the result of “2” plus “3”

More complicated arithmetic questions may be presented such as “What is the result of 387−385?” or “How many sides does a pentagon have?”

If the speech synthesis module 314 is powerful, then the arithmetic questions may be more varied since the questions or keywords of the questions will not have to be recorded ahead of time as would be the case with a less powerful synthesis module 314.

It is also within the scope of the exemplary embodiments to use other kinds of random questions. One possible scheme is to use the alphabet so that the user may only need to give a short answer similar to the digits 0 to 9 for the arithmetic questions. One type of alphabet question might be “What is the third letter of the alphabet?”.

The random questions effectively prevent computer-based attacks, just like the prompted graphic verification code when a user logs into a web site. To add difficulty for the computer based attackers who have the capability of speech recognition, the questions may be asked under various tones, frequencies and ambient noises.

To increase the difficulty of attacks, the questions may be asked and answered in a user's preferred language. The preferred language may be configured in advance or chosen via voice menu during the login process.

Answers in alternate languages may also improve the accuracy rate, as different languages have totally different voice models.

The operation of the voice-based login server 306 may be briefly described in the following way. Responsive to a user-provided first verbal answer to a first verbal question generated by the voice-based login server 306, the first-verbal answer is converted by the speech recognition module 310 to text and compared with data previously stored in the user database 316. This first verbal answer may be simply the extension number the user would like to configure. The speech synthesis module 314 provides at least one second question to the user. Responsive to a user-provided second verbal answer to the at least one second question, the speaker verification module 312 compares the second verbal answer with a voice print of the user previously stored in the user database and validates that the second verbal answer is correct for the at least one second verbal question. The voice-based login server 306 provides access to the telecommunications system if the voice print of the second verbal answer matches the voice print of the user previously stored by the voice-based login server 306.

A sample dialogue in which a user requests that a particular telephone extension be configured for the user may occur as follows:

| USER | VOICE-BASED LOGIN SERVER |
|---|---|
| User places call to | |
| Call Service Center. | |
| | Welcomes user and responds by asking |
| | the extension number that the user wants |
| | to configure. |
| | (Example “Thanks for calling ACME |
| | Company Extension Mobility System. |
| | Please say your extension number”) |
| User says the extension | |
| number (Example: user | |
| says “Four Seven Eight | |
| Four Zero”) | |
| | System decodes and if the extension is |
| | valid then says “Please say your name” |
| User says the user name | User's Response pattern is matched with |
| (Example: user says | system stored pattern (stored pattern is |
| “JOHN CITIZEN”) | gathered as part of enrollment (initial |
| | setup)) |
| | Question generator generates random |
| | question, preferably in a language other |
| | than English setup by the user (E.g., |
| | “What is the total of three plus four?”) |
| User responds with | User's response pattern is matched with |
| correct answer (example: | system generated pattern. Answer is |
| User says “seven”) | correct. |
| | Acknowledges the success |
| | (Example: “John Citizen you have |
| | been assigned extension 47840 as |
| | requested. Have a great day”) |
| | Physical extension gets the mobility |
| | number assigned |

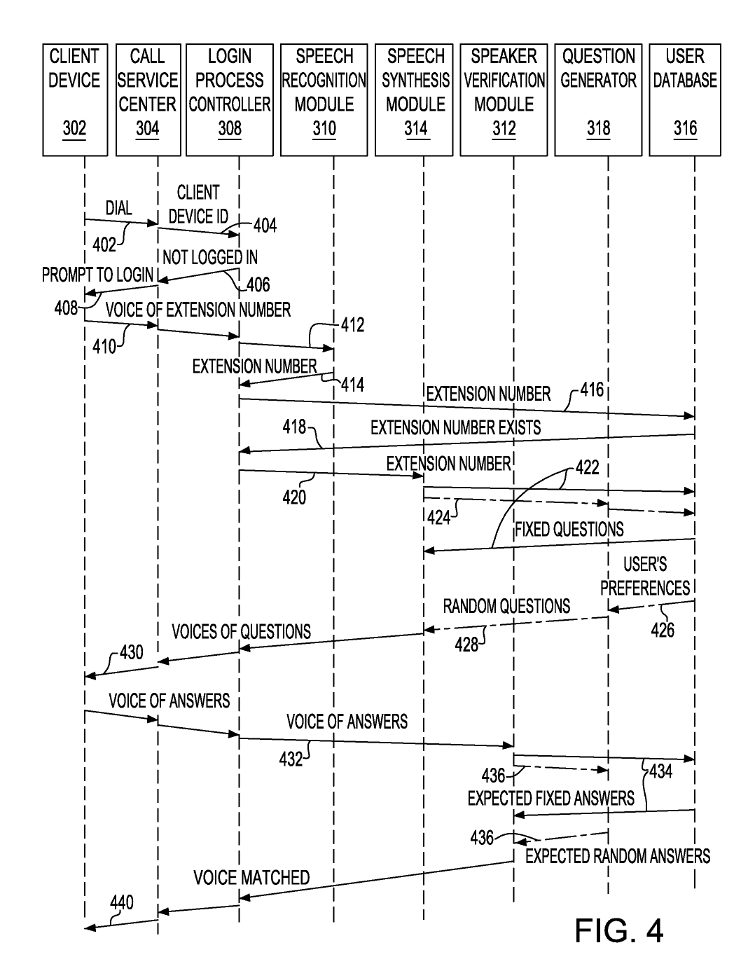

FIG. 4 shows a detailed flow chart illustrating the various processes involved in the user seeking access to the telecommunications system so that the client device 302 may be configured.

Not shown in FIG. 4 is an enrollment process where the user would answer fixed questions and the voice prints of the answers would be stored in the user database 316. Additionally, the user would record the digits 0 to 9 for the user data base 316. The digits would be recalled later when the user is prompted with the random questions. The user's recording of the digits 0 to 9 may be stored as voice prints. The user may record other data as voice prints of the user in the user data base 316. While the exemplary embodiments use only the digits 0 to 9 in the enrollment process and later on in verification for simplicity, it should be understood that other digits may be used as well such as 0 to 100 if desired to have a more complex and secure system.

Referring now to FIG. 4, a user places a call, indicated by arrow 402, to the call service center 304 via a client device 302 to login at the client device 302. The call service center 304 interacts with the login process controller, indicated by arrow 404, and determines that the client device 302 is not logged in, indicated by arrow 406. The call service center 304 prompts the user to speak the extension number of the telephone the user would like to configure (i.e., the mobility extension number), indicated by arrow 408.

The user verbally states the extension number of the telephone, indicated by arrow 410. The user's spoken extension number is forwarded to the speech recognition module 310 by the login process controller 308, and is parsed to text, indicated by arrow 412.

The speech recognition module 310 returns the text of the extension number to the login process controller 308, indicated by arrow 414.

The login process controller 308 checks the user database 316 to see if the extension number exists in the user database 316, indicated by arrow 416.

If the extension number exists in the user database 316, indicated by arrow 418, the login process controller 308 invokes the speech synthesis module 314, indicated by arrow 420.

For fixed questions, the speech synthesis module 314 retrieves the questions from the user database 316, indicated by arrows 422. For random questions, the speech synthesis module 314 invokes the question generator 318, indicated by arrow 424.

According to the user's language and other preferences configured in the user database 316, indicated by arrow 426, the question generator 318 randomly generates questions, indicated by arrow 428.

The speech synthesis module 314 may synthesize voice for the fixed and/or random questions, and may transmit the fixed and/or random questions to the user via login process controller 308 and the client device 302, indicated by arrow 430. As noted earlier, if the speech synthesis module 314 is not powerful enough, the fixed questions may be simply recorded and stored in the user database 316. Similarly, the 10 digits and other prompt phrases for the random arithmetic questions may also be recorded and stored in the user database 316. In either event, the fixed questions and random questions are provided to the user as voice rather than text.

The user speaks out answers, which are forwarded to the speaker verification module 312 by the login process controller 308, indicated by arrow 432.

The speaker verification module 312 looks up voice prints of the expected fixed answers from the user database 316, indicated by arrow 434, and/or voice prints of the expected random answers from the question generator 318, indicated by arrow 436.

The speaker verification module 312 compares the voice prints of the user's answers with the voice prints of the expected answers previously recorded by the user during the enrollment process and stored in the user database 316, and returns the result to the user via the login process controller 308 and the client device 302, indicated by arrow 440.

If there is a match between the voice prints of the user's answers and the voice prints of the expected answers stored in the user database 316, then the user is granted access to the telecommunications server and the user may configure the client device 302. Otherwise, the user is denied access.

The exemplary embodiments have the following advantages:

1) There is minimum dependency on capabilities of client devices. A traditional telephone and handset or a headset may be sufficient. There is no requirement for a screen, an (enhanced) keypad or a smart card reader.

2) There is minimum dependency on the capabilities of users. As there is no dependency on a screen, a visually impaired person may be able to use it. If there is a voice dial helper, a motion disabled person may also use it.

3) Random questions prevent computer-based replay attacks. It is difficult for a computer to recognize the random questions of the exemplary embodiments under various languages, tones, frequencies, ambient noises, etc, and cannot complete the login processes with corresponding answers, so a replay based DoS (Denial of Service) attack may be avoided effectively.

4) Questions and answers in the user's preferred language may prevent identity theft attacks. Even if the fixed voice phrase is recorded, the attacker still needs to understand the user's preferred language to reply to the random questions.

5) Limited speech processing technologies are preferred for implementation of the exemplary embodiments. Speech processing technologies required are: speech recognition for the 10 digits, from 0 to 9, to recognize the mobility extension number, speech synthesis of arithmetic questions and text dependent speaker verification which is more accurate than text independent verification.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A voice-based telecommunications login system comprising:
a login process controller to run login process instances and other modules of the login system;
a speech recognition module to receive, recognize and transform a user's voice to text;
a speaker verification module to verify the user's identity based on verbal dialogue from the user;
a speech synthesis module to synthesize a voice to provide verbal dialogue to the user; and
a user database to store voice prints of the user;
wherein, in operation, responsive to a user-provided first verbal answer to a first verbal question generated by the login system, the first verbal answer is converted by the speech recognition module to text and compared with data previously stored in the user database, the speech synthesis module providing at least one second question to the user, and responsive to a user-provided second verbal answer to the at least one second question, the speaker verification module comparing the second verbal answer with a voice print of the user previously stored in the user database and validating that the second verbal answer matches the voice print of the user previously stored in the user database; and
wherein the login system is implemented in one or more computing devices.

2. The login system of claim 1 further comprising a question generator for randomly generating questions such that the randomly generated question must be analyzed by the user to give a correct answer wherein, in operation, the randomly generated question is provided to the speech synthesis module as the at least one second question.

3. The login system of claim 2 wherein the randomly generated question is an arithmetic question.

4. The login system of claim 2 wherein the randomly generated question is only an arithmetic question.

5. The login system of 3 wherein the user database further contains user-provided voice snippets of digits 0 to 9.

6. The login system of claim 1 wherein the at least second question is a fixed question such that the fixed question and an answer to the fixed question were previously stored in the user database.

7. The login system of claim 6 wherein the user database further contains user-provided verbal answers to the fixed questions

8. The login system of claim 1 is a voice-based login system to temporarily configure a telecommunications device as the user's telecommunications device.

9. The login system of claim 1 wherein the speaker verification module uses text dependent speaker recognition.

10. A method of logging in to a telecommunications system using a login system comprising:
providing a first verbal question to a user;
responsive to a user-provided first verbal answer to the first verbal question, comparing the first verbal answer with data previously stored by the login system;
generating at least one second verbal question after confirming a match between the first verbal answer and the data previously stored by the login system;
responsive to a user-provided second verbal answer to the at least one second verbal question, comparing the second verbal answer with a voice print of the user previously stored by the login system; and
providing access to the telecommunications system if the second verbal answer matches the voice print of the user previously stored by the login system;
wherein the method is performed by one or more computing devices.

11. The method of claim 10 wherein generating the at least one second verbal question comprises randomly generating the at least one second question such that the randomly generated question must be analyzed by the user to give a correct answer.

12. The method of claim 11 wherein the randomly generated question is an arithmetic question.

13. The method of claim 11 wherein the randomly generated question is only an arithmetic question.

14. The method of claim 10 wherein generating a second verbal question comprises generating a fixed question such that the fixed question and an answer to the fixed question were previously stored in the login system.

15. The method of claim 10 wherein generating the at least one second verbal question comprises randomly generating the at least one second question such that the randomly generated question must be analyzed by the user to give a correct answer and further comprising:
generating a third verbal question such that the fixed question and an answer to the fixed question were previously stored in the login system;
responsive to a user-provided third verbal answer to the third verbal question, comparing the third verbal answer with a voice print of the user previously stored by the login system; and
wherein providing access to the telecommunications system comprises providing access to the telecommunications system if the second and third verbal answers match the voice prints of the user previously stored by the login system.

16. The method of claim 15 wherein the randomly generated question is only an arithmetic question.

17. The method of claim 10 wherein the method of logging in is voice-based and providing access to the telecommunication system includes temporarily configuring a telecommunication device as the user's telecommunication device.

18. The method of claim 10 wherein the first verbal answer is a number of a telephone extension currently being used by the user for which the user requires access to the telecommunications system and further comprising converting the first verbal answer to text and checking the login system to see if the number exists in the login system.

19. A computer program product for logging in to a telecommunications system using a login system, the computer program product comprising:
a computer readable non-transitory storage medium having computer readable program code embodied therewith, the computer readable program code comprising:
computer readable program code configured to provide a first verbal question to a user;
responsive to a user-provided first verbal answer to the first verbal question, computer readable program code configured to compare the first verbal answer with data previously stored by the login system;
computer readable program code configured to generate at least one second verbal question after confirming a match between the first verbal answer and the voice print;
responsive to a user-provided second verbal answer to the at least one second verbal question, computer readable program code configured to compare the second verbal answer with a voice print of the user previously stored by the login system; and
computer readable program code configured to provide access to the telecommunications system if the second verbal answer matches the voice print of the user previously stored by the login system.

20. The computer program product of claim 19 wherein computer readable program code configured to generate the at least one second verbal question comprises computer readable program code configured to randomly generate the at least one second questions such that the randomly generated question must be analyzed by the user to give a correct answer.
